(19) United States
(12) Patent Application Publication
(10) Pub. No.: US 2008/0029025 A1
(43) Pub. Date: Feb. 7, 2008

(54) Baluster mask

(76) Inventor: Paul Nameche, Essex, MA (US)

Correspondence Address: WOLF GREENFIELD & SACKS, P.C., 600 ATLANTIC AVENUE, BOSTON, MA, 02210-2206, US

(21) Appl. No.: 11/879,130

(22) Filed: Jul. 16, 2007

Related U.S. Application Data
(60) Provisional application No. 60/834,934, filed on Aug. 1, 2006.

(51) Int. Cl. B05B 15/04

(52) U.S. Cl. 118/505

(57) ABSTRACT

Masking to protect flooring when a baluster on the floor is being painted includes a masking sheet preformed with an opening therein inwardly of the sheet edges conforming in shape and size to the base of the baluster to be painted and having an adhesive coating on its bottom in turn covered by a release sheet that is removed before the masking sheet is applied. The masking sheet is slit from the opening to an edge so that it may be mounted on the floor about the baluster base.

### RELATED APPLICATIONS

This application claims priority under 35 U.S.C. § 119(e) to U.S. Provisional Application Ser. No. 60/834,934, entitled “BALUSTER MASK,” filed on Aug. 1, 2006, which is herein incorporated by reference in its entirety.

### FIELD OF INVENTION

The present invention relates to masks principally used to protect floors and other surfaces when balusters extending upwardly from their surfaces are being painted, stained or otherwise coated with a protective or decorative coating.

### BACKGROUND

Traditionally, painters mask stairs and flooring around balusters with tape. Sometimes masking paper is used together with the tape to cover the floor. If paper is used, it is often supplied in rolls, and the paper is applied to the floor and subsequently secured in place by tape from a tape gun. The present invention enables the worker to apply and secure the mask about the baluster as a single operation, in a precise location to afford maximum protection to the floor.

### SUMMARY OF THE INVENTION

In accordance with the present invention, the mask is preformed as a sheet that includes an opening inwardly of its edge that precisely corresponds to the shape and size of the baluster base. The sheet has a slit extending inwardly from the sheet edge to the opening enabling the mask to be placed in position on the floor and entirely surrounding the baluster base. The mask carries an adhesive coating to removably attach the mask in position on the floor. In one embodiment of the invention, the coating is covered by a film that may be peeled from the mask when the mask is to be mounted in position about the baluster base.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a perspective view of a floor surface from which two railing balusters extend, with the masking of the present invention shown applied about the base of one baluster and a second mask in the process of being applied about the base of the other.

FIG. 2 is a perspective view similar to FIG. 1 showing masks in different stages of application about the base of two balusters;

FIG. 3 is a top plan view of one mask constructed in accordance with this invention;

FIG. 4 is a plan view of another embodiment of mask constructed in accordance with the present invention;

FIG. 5 is a bottom view of the mask shown in FIG. 3 with the lower ply or release paper of the mask partially peeled from the masking or upper layer; and

FIG. 6 is a cross-sectional view of a mask taken along section line 6-6 of FIG. 5.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

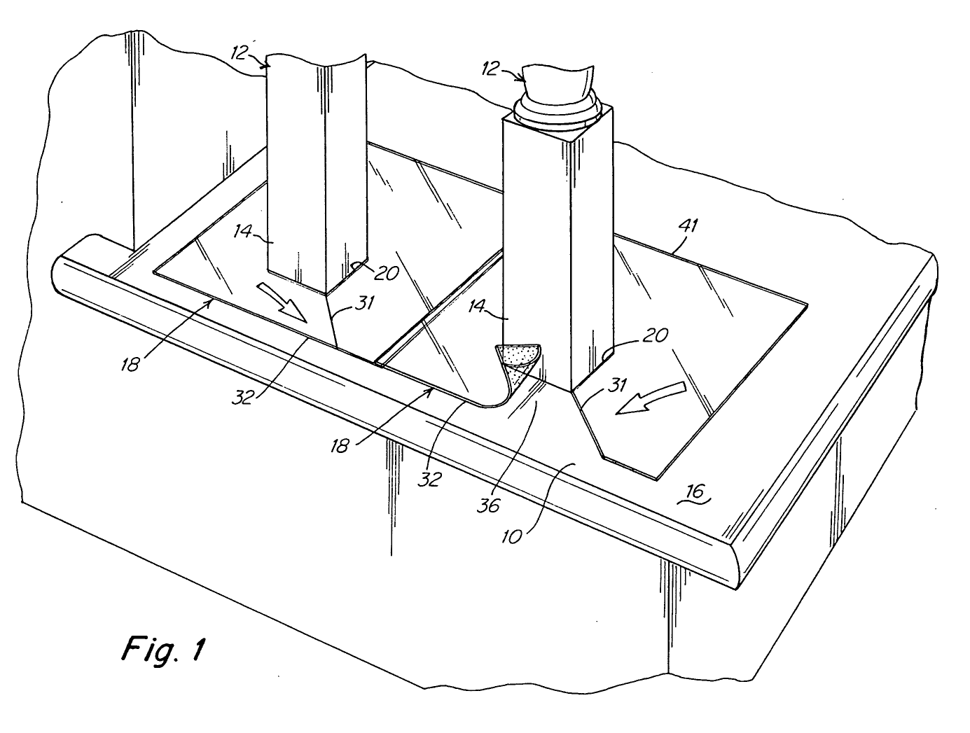

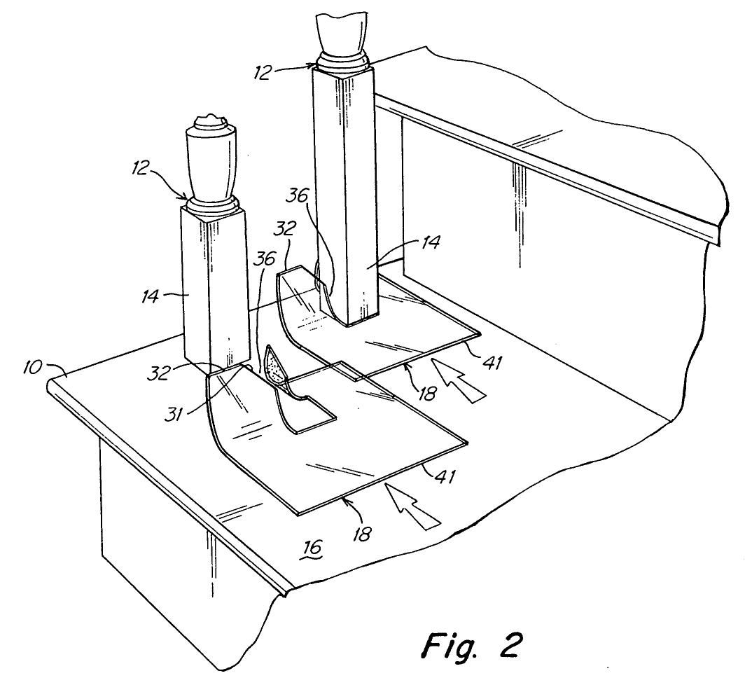

In FIGS. 1 and 2 flooring 10 is shown that may typically be an open floor, a stair landing or stair, on which two balusters 12 are also shown typical of the type used to support a hand rail. Obviously, additional balusters of any number may be present. The balusters 12 shown have a base 14 that is square in cross-section. There are four common sizes of baluster bases most widely used, two round and two square, and the present invention typically may be employed with those four sizes but may also be made to accommodate other sizes as well. The standard baluster base sizes are 1.250 and 1.750 inches square and 1.125 and 1.5625 inches in diameter. The function of the present invention is to provide a mask for the surface 16 for the floor, step or landing when the balusters are being stained, painted or otherwise coated with a decorative and/or protective coating. The invention, however, is not limited for use only with the four common sizes, but rather may be used with balusters of all sizes and shapes.

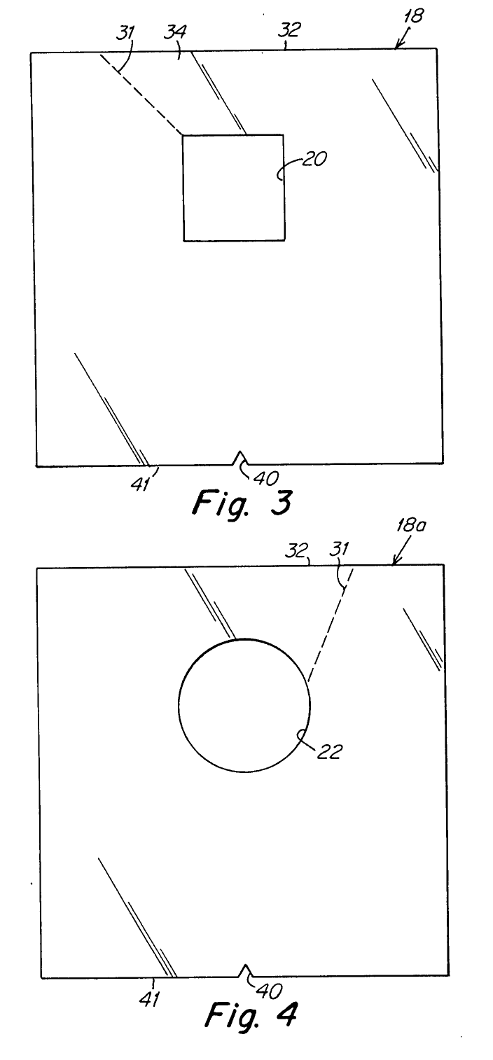

In accordance with one embodiment of this invention, the flooring is protected by separate masks 18 that are adhered to the flooring immediately adjacent the surfaces of the baluster bases. In FIG. 3, one such mask 18 is shown specifically designed for use with a baluster having a square base. The mask 18 has an opening 20 that is precisely cut to the baluster base dimension, i.e. typically 1.25 or 1.75 inches square. In FIG. 4 a different mask 18a is shown with a circular opening 22 to be used with the balusters having a round base. The diameter of the opening complements the baluster base diameter with which it is to be used, i.e. 1.125 or 1.5625 inches in diameter for standard balusters, but again may be otherwise sized for use with balusters having round bases of different diameter.

The mask 18 as shown in FIG. 6 comprises an upper masking ply 26 typically made of a PVC material that preferably is translucent or transparent and has an approximate thickness of 0.01 inch. The thickness may vary depending upon the specific application. For example, the nature of the coating material to be applied to the balusters may dictate the use of a different weight and thickness for the mask. Furthermore, while the use of light pervious material is preferred with certain applications, it should be appreciated that opaque material may also be used and materials other than PVC such as paper or different plastics in different applications may also be employed. In certain applications the mask may be prefabricated with two or more openings to accommodate two or more balusters.

In addition to the primary sheet or masking layer 26, the mask 18 in accordance with one embodiment of the invention includes an adhesive layer 28 and a peelable sheet 30. The bottom surface 27 of the mask sheet 26 preferably is entirely coated with the adhesive layer 28 such as an acrylic pressure sensitive adhesive. Other adhesives may be used as well, although acrylic based adhesives are preferred. The adhesive should possess sufficient strength to adhere to the surface of the floor without marring the floor surface or leaving a sticky deposit on the floor when the upper masking ply 26 is removed. The adhesive layer 28 in turn is covered by the peelable sheet 30 commonly termed a release paper, that is removed before the masking layer is placed about the baluster.

The mask 18 preferably including both the top ply 26 and peelable sheet 30 is provided with a slit or perforated tear line 31 that extends from the cutout portion 20, 22 to the nearest side edge 32 of the sheet. The slit in the embodiment of FIGS. 1-3 preferably extends at an angle of approximately 45° to the edge 32 that it intersects so as to create a narrower portion 34 at the edge, which will enable the user to more easily peel the release paper 30 from the masking ply 26 and bend the masking ply 26 to open a passage 36 formed by the slit to mount the mask about the base 14 of the baluster. The slit 20 in one embodiment, extends through the top ply 26, adhesive layer 28, and the release paper 30 but may be confined to the top ply with or without the adhesive in other embodiments of the invention.

In the embodiment of FIG. 4 the slit 31 preferably extends from the side of circular opening 22 to the closest side edge 32 of the sheet also to effectively decrease the length and increase the width of the passage through which the round baluster base must pass to reach the opening 22. The slit or perforated tear line 31 preferably may extend at an angle other than 90° to the edge 32 so as to make it easier to separate the masking sheet from the flooring when the masking sheet is to be removed.

To assist in removing the masking ply 26 from the flooring after the painting or other coating of the baluster is completed, a notch or cut out 40 may be provided in the edge 41 of the masking sheet most remote from the opening 20, 22. The notch or cut out 40 will assist the user in separating the edge of the mask from the flooring and is located on the side of the baluster nearer to the floor area normally occupied by the person performing the task.

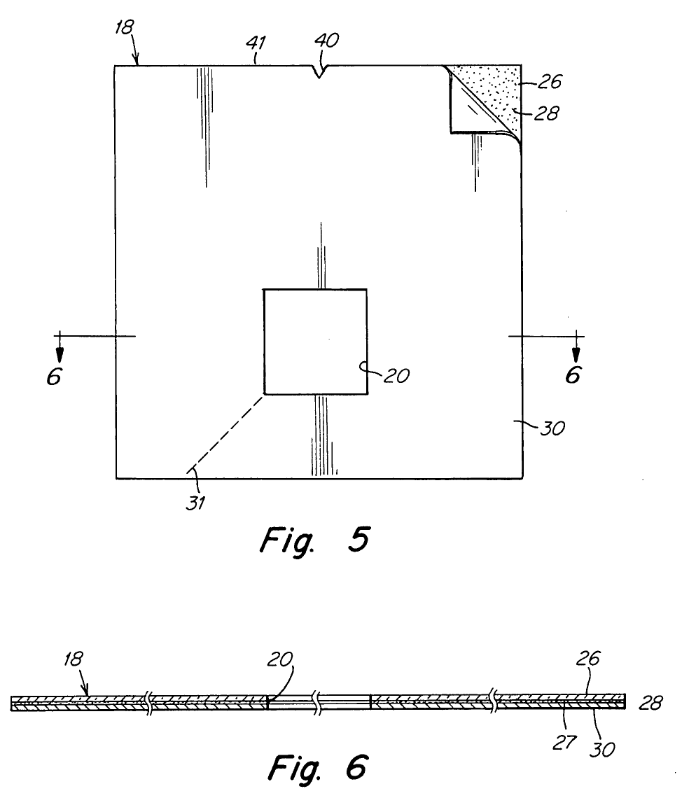

When masks are to be applied about the balusters the release paper is removed from the masking ply for each baluster as suggested in FIG. 5. The masking ply is then separated at the slit or perforated tear line as shown adjacent the left baluster in FIG. 2 to create the passage 36, and slipped about the baluster as shown at the right balusters as viewed in FIGS. 1 and 2. Thereafter the masking ply is pressed firmly against the flooring so as to adhere the mask in place as shown about the left baluster in FIG. 1. The masks are applied one at a time until the flooring about all the balusters is covered. After the paint or other coating has dried, the masks are removed by peeling them off the flooring and this may be assisted by the presence of the notch 40 as shown in FIG. 4.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A baluster mask comprising
a precut masking sheet of light pervious material exceeding the cross-sectional size and shape of a baluster about which the mask is to be applied,
an adhesive coating on the bottom side of the sheet,
a removable cover sheet overlying the adhesive coating on the masking sheet and peelable off the coating,
a precut opening in the masking sheet inwardly from its edges and conforming in size and shape to the cross-section of baluster base with which it is to be used,
and a slot in the multi-ply masking sheet extending from the opening to an edge of the masking sheet for enabling the mask to be placed about the baluster base after the removable cover sheet is removed.

2. The baluster mask as defined in claim 1 wherein the sheet is made of a plastic material.

3. A baluster mask comprising
a multi-ply flexible member including a first sheet having an adhesive coating on one side in turn covered by a release sheet,
a precut opening through the member and inwardly of the edges thereof, said opening conforming in size and shape to the baluster to be masked,
and a slit in the member extending from the opening to the edge of the member enabling the member to be twisted so as to permit the member to be mounted about and surrounding the baluster.

4. The baluster mask as defined in claim 3 wherein the slit extends through the first sheet and adhesive coating.

5. The baluster mask as defined in claim 3 wherein the opening conforms in size and shape to a standard baluster base.

6. The baluster mask as defined in claim 5 wherein the opening is round.

7. The baluster mask as defined in claim 5 wherein the opening is square.

8. The baluster mask as defined in claim 6 wherein the diameter of the opening is one of 1.125 inch and 1.5625 inch in diameter.

9. The baluster mask as defined in claim 7 wherein the opening is one of 1.250 and 1.750 inches square.

10. The baluster mask as defined in claim 3 wherein a notch is cut in an outer edge of the first sheet for facilitating removal of the masking.

11. The baluster mask as defined in claim 3 wherein the adhesive coating is an acrylic pressure sensitive adhesive.

12. The baluster mask as defined in claim 3 wherein the first sheet is a PVC material.

13. The baluster mask as defined in claim 12 wherein the adhesive coating is an acrylic pressure sensitive adhesive.

14. The baluster mask as defined in claim 13 wherein a notch is cut in an outer edge of the first sheet for facilitating removal of the masking.

15. The baluster mask as defined in claim 14 wherein the present opening is one of either square or round.

16. The baluster mask as defined in claim 3 wherein the mask is prefabricated.
